(19) United States
(12) Patent Application Publication
(10) Pub. No.: US 2010/0017725 A1
(43) Pub. Date: Jan. 21, 2010

(54) AMBIENT COLLAGE DISPLAY OF DIGITAL MEDIA CONTENT

(75) Inventors: Joseph F. McCarthy, Corvallis, OR (US); Yogi Patel, Corvallis, OR (US); Sameer Ahuja, Corvallis, OR (US); Shelly Farnham, Corvallis, OR (US); William R. Hazlewood, Corvallis, OR (US); Josh Lind, Corvallis, OR (US)

Correspondence Address: Stolowitz Ford Cowger LLP, 621 SW Morrison St, Suite 600, Portland, OR, 97205, US

(73) Assignee: Strands, Inc., Corvallis, OR (US)

(21) Appl. No.: 12/506,538

(22) Filed: Jul. 21, 2009

Related U.S. Application Data
(60) Provisional application No. 61/082,479, filed on Jul. 21, 2008.

(51) Int. Cl. G06F 3/01; G06F 17/30; G06F 15/16

(52) U.S. Cl. 715/745; 707/10; 709/206; 707/E17.032

(57) ABSTRACT

Disclosed are methods and systems for automatically displaying media items (130) preselected by a user (110) on a collage display (700) located at a social gathering spot when the user is present. A user of the system sets up a personal online profile (110) through a website (100,200) and the profile identifies a portable device (500) associated with the user. User online profiles (110) are stored in a database (400) on a system web server (300), and may include selected media items (132) selected by the user. At a venue, the user's presence is automatically detected by various electronic means, and a personalized welcome message (702) may be displayed on the collage display screen (700) to notify other patrons of the venue. Users present may comment or vote (182,184) on the media items seen on the collage display, as well as send text messages to the display (164,750).

### RELATED APPLICATIONS

This application claims priority from U.S. provisional application Ser. No. 61/082,479 filed Jul. 21, 2008, and incorporated herein by this reference.

### COPYRIGHT NOTICE

©2008-2009 Strands, Inc. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This invention pertains to methods and systems to implement a dynamic visual media display or “electronic collage” that is responsive to the individuals who are physically present at a venue in which the display is located.

### BACKGROUND OF THE INVENTION

Cafés and coffeehouses are quintessential third places: semi-public places away from home (first places) and work (second places) where people can gather to enjoy conversation and community with friends and strangers. Café and coffeehouse owners provide this social environment to patrons and in return earn a profit on sales of goods and services.

Although many cafés are designed to encourage conversation and community interaction, the growing proliferation of technology, especially laptops with wireless Internet access and mobile phones, is rendering many such places “physically inhabited but psychologically evacuated.” Café patrons often use technology to tunnel out to their online community, while ignoring the physical community in which they are situated. What is needed is a way to promote conversation and community among café patrons, while ensuring a level of sales receipts to allow the café or coffeehouse to turn a decent profit, and thus be able to continue to provide their social meeting place to the public.

### SUMMARY OF THE INVENTION

The following is a summary of the invention in order to provide a basic understanding of some aspects of the invention. This summary is not intended to identify key/critical elements of the invention or to delineate the scope of the invention. Its sole purpose is to present some concepts of the invention in a simplified form as a prelude to the more detailed description that is presented later.

A method is herein disclosed as comprising, in one embodiment, receiving preference data for a user into a database, wherein the preference data is associated with media, and linking or associating the preference data to a user-specific portable device whose physical presence may be detected, for example, in a café or other location. Upon detecting presence of the user portable device, a media item of the media associated with the preference data of the detected user portable device is displayed on a collage display.

A system is herein disclosed as comprising, in one embodiment, a server configured to receive user preference data into a database, wherein the user preference data is associated with media, and a user portable device, wherein the user portable device is associated with the user preference data through the database. The system further includes a device detector configured to detect the presence of the user portable device, and a collage display configured to display received user preference data upon detection of the linked user portable device.

A system is herein disclosed as comprising means for receiving preference data for a user into a database, wherein the preference data is associated with media, and means for linking the preference data to a user portable device. The system further comprises means for detecting the physical presence of the user portable device, and means for displaying a media item of the media associated with the preference data of the detected user portable device on a collage display.

A computer-readable medium having executable instructions stored thereon is disclosed herein. When the instructions are executed by at least one device, the device is configured to receive preference data for a user into a database, wherein the preference data is associated with media, and link the preference data to a user portable device. The device is further configured to detect the physical presence of the user portable device, and display a media item of the media associated with the preference data of the detected user portable device on a collage display.

Additional aspects and advantages of this invention will be apparent from the following detailed description of preferred embodiments, which proceeds with reference to the accompanying drawings.

### BRIEF DESCRIPTION OF THE DRAWINGS

FIG. 1 shows the architecture of the collage display system.

FIG. 2 illustrates an exemplary user profile webpage.

FIG. 3 illustrates a display of a history of media, or media stream of media items that have been shown on a collage display.

FIG. 4 shows an exemplary welcome screen shown on a collage display.

FIG. 5 shows a collage of exemplary images, linked to patrons, on a collage display.

FIG. 6 shows a collage of exemplary images on a collage display, along with an exemplary text message of a patron to other patrons.

### DETAILED DESCRIPTION OF PREFERRED EMBODIMENTS

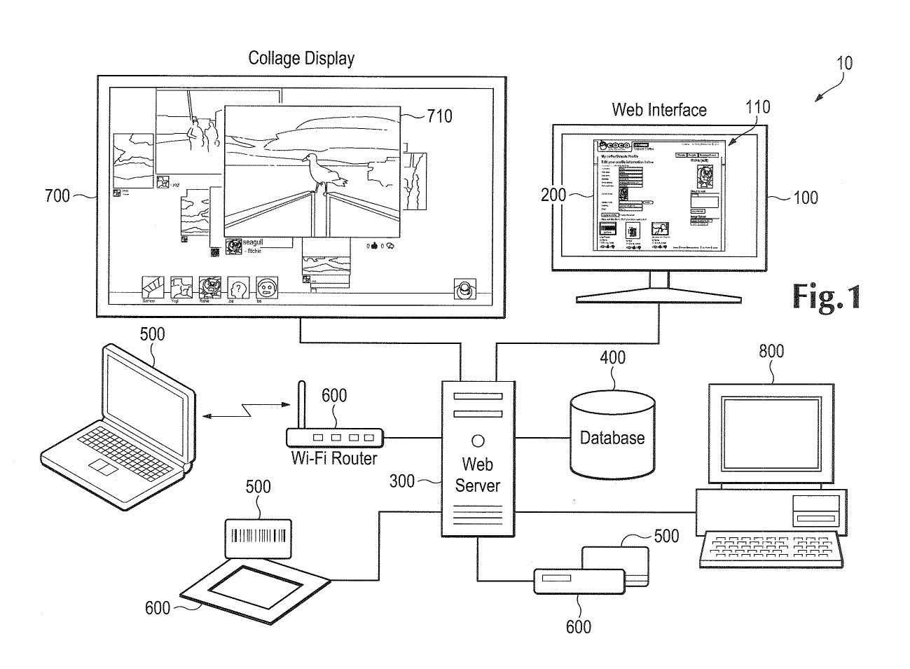

FIG. 1 shows a system 10 in a presently preferred embodiment. The system 10 comprises a number of system components. In one scenario, a café, bookstore, or other venue would host its own collage system. These systems need not be centrally interconnected or managed. On the other hand, some centralization or sharing may be useful. In such embodiments, each venue has its own URL, and they appear to be standalone, though on the back end there may be a central hosting service that supports all of them. Preferably, there is no front-end centralization or coordination across venues (from the users' or venue owners' perspectives), but again there may be some centralization on the back-end. User's might be allowed to upload or transfer information (user profile, media items, etc.) from one venue web site to another (assuming that suitable security, anti-spam arrangements and the like are implemented.) A central server could be arranged to distribute content, announcements, or advertising to multiple venue sites.

We proceed with the description of a single venue web site. An online profile management webpage 100 enables customers to create an online profile 110 on a web site through web interface 200. The online profile 110 enables users to upload, or link to, media that the user wishes to share. The web interface 200 is hosted on web server 300, which comprises a database 400 that stores profile information 110. Web interface 200 also allows users to share media by enabling users to vote on or comment on others' shared media (not shown). “Media” refers to any one or more digital media items, including without limitation audio, video, photographs, text, graphics, etc. and combinations of any of them.

The presence of a user's portable device 500 is detected by a presence detector 600. In one embodiment, portable device 500 comprises a machine-readable loyalty card containing either magnetic stripe or barcode, and the presence detector 600 comprises a magnetic card reader or an optical scanner. In another embodiment, portable device 500 comprises a wireless device such as a laptop computer or a Personal Digital Assistant or a cell phone, and presence detector 600 comprises a wi-fi router or a Bluetooth scanner. The portable device 500 links a user with an associated user profile 110 on the web server 300. In another embodiment, RFID technology may be used (not shown).

An electronic collage display 700 shows a continuously updated collage of media items 710 from people within the café community, prioritizing those people whose portable device 500 has recently been detected by presence detector 600. An administrative interface 800 enables café owners and employees to control the behavior of system 10 and manage its users. These will be described in more detail in the following sections.

### Online Profile Management

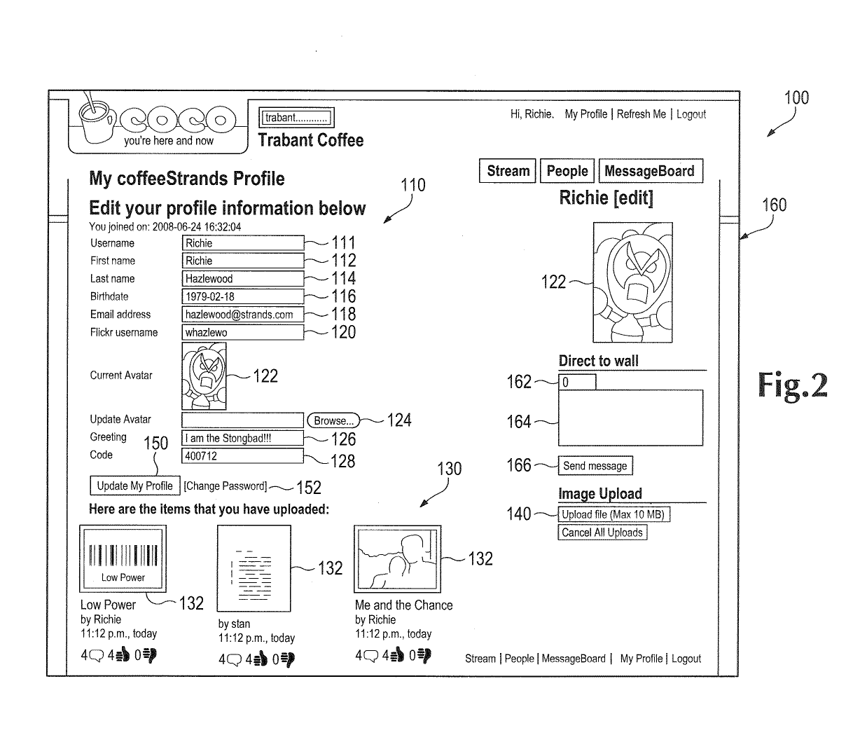

Turning now to FIG. 2, an exemplary screenshot of an online profile management webpage 100 is shown. The profile management webpage 100 enables a person to create or modify a user account. Each account preferably has an associated username 111 and user password (not shown) used to log in to the system. Each account also may have an associated first name 112, last name 114, email address 118, avatar 122, avatar update button 124, greeting 126, and a portable device identification code 128, along with a user's media pool 130 that comprises a list of digital media links or thumbnails 132, which can be specified in a number of ways. For example see [0048] below. In some embodiments, use of actual first and or last names may be discouraged or even prohibited. A short personal biography or “blurb” may be included. In a preferred embodiment, a user comment icon 180, a thumbs up icon 182, and a thumbs down icon 184 accompany each media link or thumbnail 132.

The user comment icon 180 provides a link to comments made by other users about the particular media item 710 associated with the particular user media link or thumbnail 132, and has an adjacent number indicating the number of comments associated with the item at a particular point in time. Each of the thumbs up icon 182 and thumbs down icon 184 similarly has an adjacent number, here indicating the number “thumbs up” and “thumbs down” votes the media item 710 has received. There is also an optional field for the user's birthdate 116, so that the display 700 can show a special birthday greeting on that day if the user visits the café. In addition, there is an upload button 140 for uploading user media links or thumbnails 132 to the user's media pool 130 of the user's online profile 110.

The user can preferably specify digital media that is to be shared implicitly or explicitly. Implicit media specifications may take the form of RSS feeds that tap into media items generated through other web services, e.g., the Flickr™ photo-sharing service or the Twitter™ text messaging service. Each implicit stream is represented by an implicit stream username 120 (on the hosting web service), along with include terms and/or exclude terms (not shown). If include terms are specified, only media items that include those terms in their metadata (e.g., title, tags or description) are included in the user's personal media pool 130. If exclude terms are specified, only media items that do not include those terms in their metadata are added to the user's media pool 130. If the implicit stream username 120 is omitted, the include terms may be used to conduct a general search for items that include those terms (from any user of the other web services). For example, with a blank implicit stream username 120 and the include term “horses”, any Flickr™ photos with “horses” in their titles, tags or descriptions would be candidates for inclusion in the user's media pool 130. In a preferred embodiment, an administrator may limit the amount of implicit media that may be loaded to a user's media pool 130.

In one embodiment, the system 10 automatically refreshes implicit content in a user's media pool 130 every time the user checks in (e.g., the user's portable device 500 is detected by the presence detector 600), so that the user's media pool 130 grows over time with each visit (and purchase). In another embodiment, a user can manually refresh the implicit content in his or her user's media pool 130 at any time by visiting his or her profile page and clicking a “refresh” button (not shown) located next to any implicit media stream specification. Another alternative is importing photos from Facebook photo albums (via a Facebook app). In a presently preferred embodiment, this feature doesn't require (or permit) the use of “include” or “exclude” keywords, but instead requires a user to login to Facebook, specify a photo album, and then specify one or more photos in that album to add to their collage profile.

Explicit media specifications may take the form of a local file name (accessed through a file browser pop-up window), a URL, or a free text field, e.g., for an inspiring quotation or other short message to be shared with others. Each explicitly specified media item is shown on a person's online profile 110, as discussed above, and may be removed from the user's media pool 130 by selecting the item and pressing the “delete” key on a user's computer keyboard (not shown). Alternately, embodiments may include a “delete” button next to each item that the user may select when the user wants to eliminate that item from the user's media pool 130. The number of explicit media items that may be uploaded to a user's media pool 130 may be limited in some embodiments, for example to a maximum of 10 photos at a time, to conserve server 300 storage space.

In a preferred embodiment when a user makes changes to his or her online profile 110, an “Update My Profile” button 150 is selected to input the changes to the database 400 of the web server 300. In addition, a “change password” link 152 may be provided that activates a webpage with new password and new password confirmation fields (not shown).

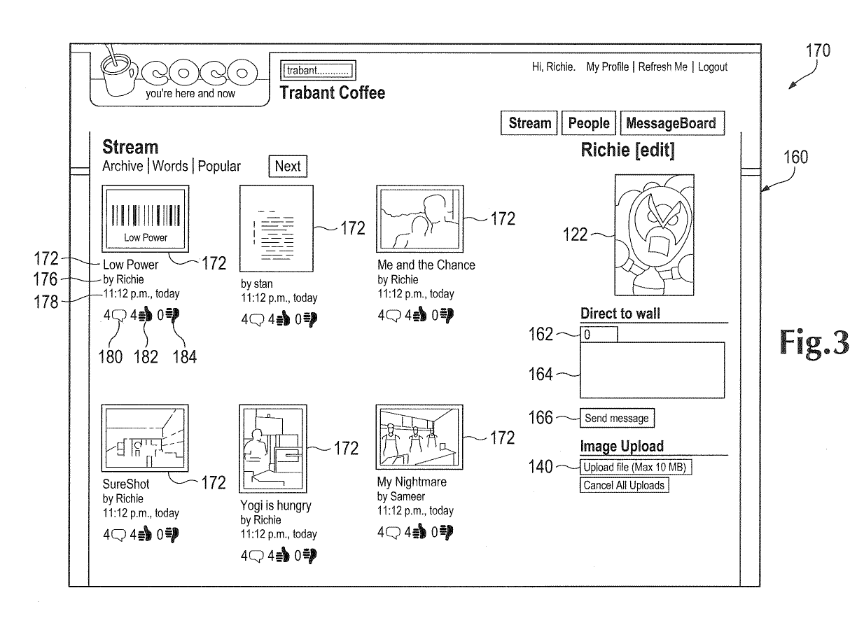

In some embodiments the profile management webpage 100 includes a user's in-café display messaging portion 160 (FIG. 3). The user's in-café display messaging portion 160 comprises an interface through which a user may send messages to the collage display 700 (“direct to wall”), and comprises a direct to display selection box 162 (for cafes having more than one separate displays that do not display identical simultaneous collages), along with a text message box 164, where the user may enter text to be shown on the collage display 700. A send message button 166 is used to send the message to the collage display 700 once the message has been completed.

### Online Interaction

In addition to supporting the creation and maintenance of a user's online profile 110, the system 10 supports other types of online interaction as well. Users may view others' profiles (excluding passwords or other information deemed sensitive by the profile owner) and the media in those profiles. Users may also access a display history webpage 170, as shown in FIG. 3, to browse through the stream of media items that have been shown on the collage display 700 of the particular café. To access this page, a user selects a particular café of interest from a café selection webpage (not shown). The café's display history webpage 170 contains media thumbnails 172 that may include such information as the title of the media item 174, the name of the user submitting the media 176 (which may comprise that user's username 111 or first name 112 for example), and the date and time that the media item was displayed 178. In an embodiment the media thumbnails 172 link to the larger scale media item 710 (not shown here), which may be displayed, for example, in a popup window by double-clicking on the media thumbnail 172.

In one embodiment, users can input, through the display history webpage 170, their impressions of the particular media items displayed. A comment icon 180 may accompany the media thumbnail 172, which links to a text field into which a user may submit a comment about that particular media item. Some embodiments may include a thumbs up icon 182 and a thumbs down icon 184 that users may select to vote upon a particular media item 710 of interest.

In a preferred embodiment, users may flag a particular media item 710 as being inappropriate, for example, by selecting the media thumbnail 172 of that item and then selecting an “Inappropriate Content” button (not shown) so that a system administrator can review that item for potential removal from the database and appropriate disciplinary action taken with the user having that media item in his or her user's media pool 130. Content that is flagged as inappropriate by any user may have a “Flagged” image and label superimposed upon it (not shown), pending a decision by a system administrator. In one embodiment, flagged content items may still be voted or commented on by other members of the user community.

As mentioned above, system users who physically are in the café can also send messages directly to that café's collage display 700 via the text message box 164 in the user's in-café display messaging portion 160 of their online profile 110. These messages become part of the display history shown on a café's display history webpage 170 and are also represented by a media thumbnail 172, and can thus be commented or voted on, but do not become part of any user's media pool 130.

To foster community development, users may also communicate with each other as a group, for example through the public message board, or with each other directly through private messaging. These channels of communication are not shown on the collage display 700.

### Presence Detection

A user may be detected though the detection of their portable device 500 by presence detector 600, as shown in FIG. 1. As mentioned above, the portable device 500 links a user entering a café to his or her online profile 110 through portable device identification code 128 (see FIG. 2). In an embodiment, the portable device 500 (see FIG. 1) comprises a machine-readable loyalty card having a magnetic stripe, or a barcode, and the presence detector 600 comprises a magnetic card reader, or a scanner, respectively, depending on the kind of loyalty card program in place at the café. When the card is swiped or scanned at or near a point-of-sale (PoS) terminal (not shown), the person associated with the card is added to the pool of users considered present. In this embodiment, users will initially check in or “announce” their presence explicitly by using the loyalty cards when making a purchase. The system may display a welcome message automatically in response to use of the card. Cafés may also allow users to use their cards at other times, or at another place (e.g., a kiosk) within the café, either to refresh their presence or enable other kinds of interaction, e.g., scanning the barcode on a book cover (“what I'm reading”) or taking a photo with a camera mounted in the café (not shown) to associate with their profiles.

In other embodiments portable device 500 comprises a wireless microprocessor-based device such as a laptop computer or a personal digital assistant (PDA) or a cell phone, and methods to “check in” may include both explicit methods, such as having users check in manually through a text message, as well as implicit methods to “check in” such as detecting a MAC address of a users' wireless device on the café's wi-fi network, or by using a Bluetooth scanner to detect the Bluetooth names of phones or laptops users have explicitly associated with their profiles, splash pages for enabling people to login whenever they connect to the internet in the café. Another option is “SMS Check-in”. If a user optionally specifies a mobile phone number in his/her profile, he/she can send a text message to “41411” from that phone with a keyword indicating the name of the venue (e.g., sending a message “trabant” to 41411) to signal that his/her presence in the café.

### Collage Display

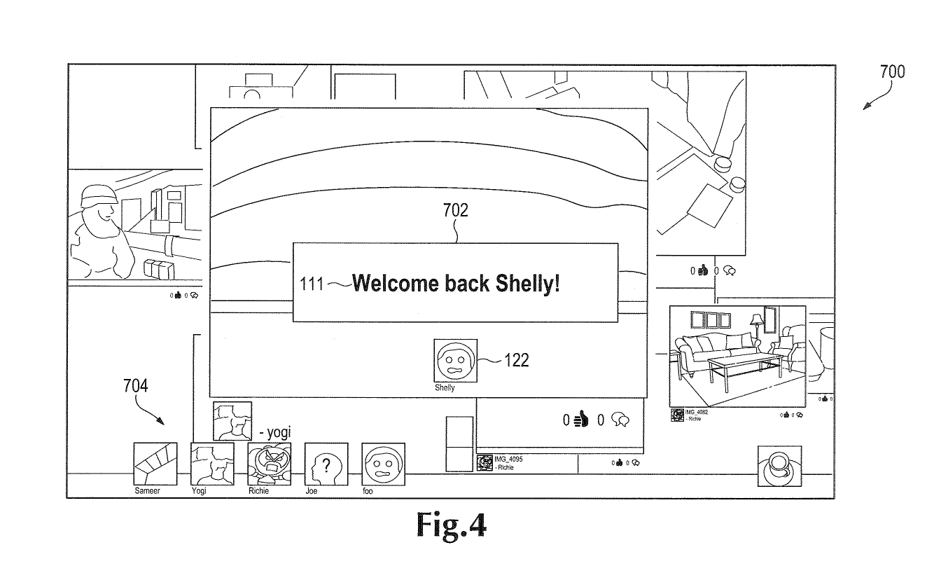

Turning now to FIGS. 4-6 there is shown a collage display 700. In one embodiment, the collage display 700 comprises several large-screen display panels covering walls of the café and linked so that a collage image is first displayed on a primary panel and then pans across the display panels so that a continuous image may be seen transferring from one panel to an adjacent panel (not shown). The primary panel is typically located in the café so that it is readily seen by café customers as they purchase goods, as well as by those waiting in line to be served. In other embodiments, the collage display 700 comprises a single large panel.

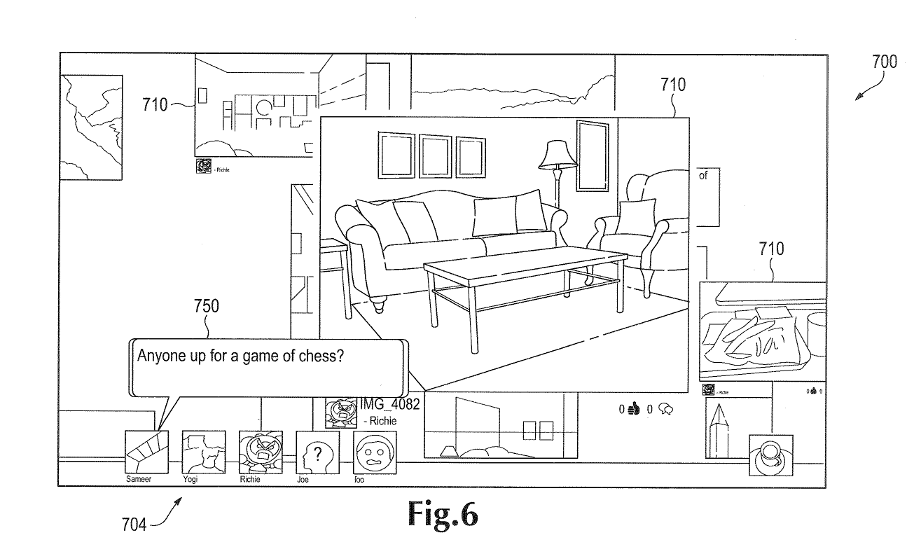

The collage display 700 preferably is updated with a new image or short text message periodically, for example every 15 seconds. When a person's presence is first detected, a welcome message 702 may be displayed (see FIG. 4), and the person's avatar 122 and username 111 are shown in the center of the screen. After a predetermined amount of time, the avatar 122 and username 111 are moved to an outer portion of the collage display 700, for example the bottom left portion of the collage display 700, to the head of a queue 704 of users recently detected in the café. When a user subsequently sends a message directly to the display, the message pops up in a message bubble 750 above the user's avatar 122 as shown in FIG. 6. The system may periodically ping a user to determine whether or not he is still physically present at the venue. In this regard, the system may keep a rolling attendance list, and take it into account in refreshing the collage display.

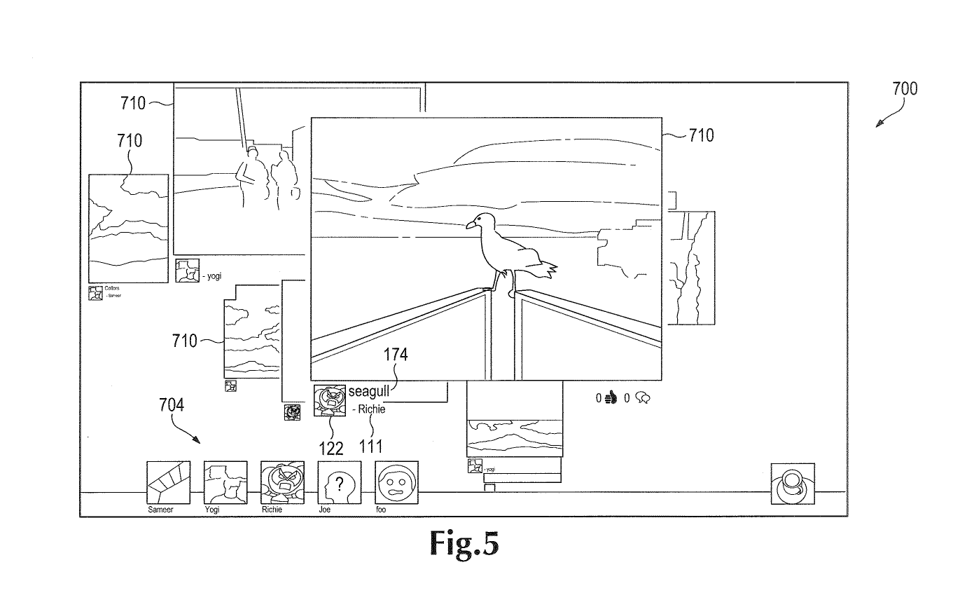

After the initial welcome message 702 is displayed, a media item 710, comprising for example a photo or text message, from the recently detected user's media pool 130 is shown in the center of a collage display 700 panel (see FIG. 5), along with the title of the media item 174, the username 111, and the user's avatar 122.

In one embodiment, the collage is a 3D space as viewed from a position perpendicular to the planes of the individual media items 710. The perceived distance of an image from a “virtual camera,” or relative size of the image, is proportional to the amount of time the image has been shown the collage display 700. Whenever a new media item 710 appears at the center of the collage screen, a semi-random algorithm may be used to determine its final position so as to uniformly fill the visual space. Alternately, a media item 710 may be ultimately positioned according to the date and time the media item was (first) displayed 178, for example, or alphabetically according to username 111, or according to a location within the café in which the user plans to sit.

In some embodiments, the virtual camera performs a randomized pan motion around the displayed media items 710 every few minutes. In other embodiments, the primary collage display 700 may occasionally rotate through alternative views, showing overviews of all members active within the past day, week, or month and all content active within the last day, week, or month.

The selection of the next item to be added to the collage is based on an algorithm. The algorithm comprises code on a computer-readable medium that instructs the computer to display a media item 710 on collage display 700. The algorithm may be based upon several factors, for example:
ItemTimeSubmitted
ItemTimeLastShown
ItemThumbsUpCount, ItemThumbsDownCount
ItemThumbsUpTime, ItemThumbsDownTime
ItemCommentCount
ItemCommentTime
PersonTimeLastSeen
PersonTimeLastServiced

The algorithm prefers items that have been submitted recently and/or not shown recently, with recent and/or many “thumbs up” votes, few “thumbs down” votes, recent and/or many comments. It also prefers people who have checked in recently and/or who have not had one of their items shown recently. Alternately, the algorithm may be configured to be influence by other factors such as the amount of money spent by a user or a frequency of user detection by presence detector 600.

In one embodiment, the next item selection algorithm takes into account the following, using a weighted sum of normalized values:
positivity score (ItemThumbsUpCount−ItemThumbsDownCount)
activity score (ItemThumbsUpCount+ItemThumbsDownCount+ItemCommentCount)
last display score (CurrentTime−ItemTimeLastShown)
presence score (CurrentTime−PersonTimeLastSeen)
age score (CurrentTime−ItemTimeSubmitted)
and a small amount of random fuzz.
   Each of these scores preferably is weighted and normalized. A weighted random selection is then made based on the normalized scores.

While a preferred embodiment of the collage display 700 uses a metaphor of an image of a media item 710 that gradually recedes as new media items 710 appear in a 3-dimensional rendering of the collage, other metaphors and designs are also contemplated. Additionally, algorithms including other factors such as what type of content the item is (photo vs. text, implicit vs. explicit specification), the size of the overall content pool for the user are contemplated. Better discrimination between, and differential handling/weighting of, media items 710 associated with café customers, café employees and the café itself are also contemplated.

### Advertising and Co-Promotional Opportunities

Cafés may want to sell time and/or space on the collage display 700 to other businesses. In some embodiments, advertisements may be a part of the general collage metaphor, preserving the ambience of the display, simply introducing advertising content to augment personal content as part of the overall media mix. In addition, individual users may want to incorporate items that they are selling or want to buy, e.g., on Craigslist® or eBay®, as part of their overall profiles, creating a new, location-based personalized and situated channel for buying and selling goods and services among the café customer community. In an alternative embodiment, advertising may be marketed and sold by a separate entity, which would then download advertising content to multiple participating venue sites for display on their respective collage display systems.

Cafés may also want to invite their customers to endorse products or services, either sold within the café, or by other businesses. Users may thus be enabled to incorporate advertisements as part of their personal online profiles 110, and/or to have their avatars 122 associated with advertising content when it appears on the collage display 700.

### Administrative Interfaces

Like other users, the venue administrators—owners or employees at the café—can view the display history webpage 170, as well as vote or comment on media items 710. Unlike other users who can only flag content items as inappropriate, venue administrators can either accept or reject an item that has been flagged as inappropriate through the administrative interface 800. Media thumbnails 172 of media items 710 that are deemed inappropriate by venue administrators will be blacked out on the display history webpage 170, while those that are deemed appropriate will be restored from a flagged image to a normal view. In addition, in some embodiments, a venue administrator may ban a user (not just a single item), which has the effect of immediately removing all of that user's items from the screen and the web site, disables further use of the account, and prevents the email address from being associated with any future accounts at that venue.

A “system administrator” interface may also be implemented. Essentially, the system administrator has a superset of the capabilities of a venue administrator. For example, a system administrator may add café owners and employees to the pool of people who are considered present (vs. requiring them to use a loyalty card to notify the system of their presence). This is because café owners and employees will generally come and go less often—and stay far longer—than customers of the café.

In a preferred embodiment, the administrative interface 800 primarily supports the management of users and their content, e.g., moderating content that has been flagged as inappropriate or banning users who consistently share media items or post direct messages that violate the policy of acceptable use in the café. Other embodiments include expanded interfaces that include control over various channels of content, for example, external advertising content incorporated into the collage display 700, as well as the conditions that determine where and how such content is displayed on the collage display 700.

### Media and Media Items

“Media” is used herein to refer to one or more digital media files, for example text messages, music tracks, digital photos, video clips or any other “content” that can be played aurally, displayed for viewing, etc. Playing or viewing may be interactive or passive. Media items may be assembled into a “mediaset”—akin to a photo album—as further discussed later. (In general, a playlist is just that—a list of media items, as distinguished from the actual media items themselves (also called content)). In that sense a playlist or mediaset comprises metadata.

“Media” or media items, should not be confused with digital storage media, which are physical devices that store digital data. (We use the term data broadly, to include without limitation programming or software code, metadata, content data, etc.) Caution should be exercised to avoid confusion where, for example, we discuss the storage of (digital) media items in digital storage media, such as a memory device. Additional discussion of storage media is appended below. Unfortunately, this tangent has become necessary because of bizarre positions taken by the examining corps in the U.S. Patent and Trademark Office with respect to patentable subject matter under Title 35 U.S.C. §101, and the patent application requirements of Title 35 U.S.C. §112.

### Digital Processor and Associated Memory

As explained above, the invention preferably is carried out by a digital computing system. See collage display system architecture diagram, FIG. 1. By the term digital computing system we mean any system that includes at least one digital processor and associated memory, wherein the digital processor can execute instructions or “code” stored in that memory. (The memory may store data as well.) A digital processor includes but is not limited to a microprocessor, multi-core processor, DSP (digital signal processor), processor array, network processor, etc. A digital processor may be part of a larger device such as a laptop or desktop computer, a PDA, cell phone, iPhone PDA, Blackberry® PDA/phone, or indeed virtually any electronic device. In FIG. 1, each of the display 700, the presence detector 600, the web server 300, and in some embodiments the portable device 500, comprises a digital computing system.

The associated memory, further explained below, may be integrated together with the processor, for example RAM or FLASH memory disposed within an integrated circuit microprocessor or the like. In other examples, the memory comprises an independent device, such as an external disk drive, storage array, or portable FLASH key fob. In such cases, the memory becomes “associated” with the digital processor when the two are operatively coupled together, or in communication with each other, for example by an I/O port, network connection, etc. such that the processor can read a file stored on the memory. Associated memory may be “read only” by design (ROM) or by virtue of permission settings, or not. Other examples include but are not limited to WORM, EPROM, EEPROM, FLASH, etc. Those technologies often are implemented in solid-state semiconductor devices. Other memories may comprise moving parts, such a conventional rotating disk drive. All such memories are “machine readable” in that they are readable by a suitable digital processor as further explained below.

### Storage of Computer Programs

As explained above, the present invention preferably is implemented or embodied in computer software (also known as a “computer program” or “code”; we use these terms interchangeably). Programs, or code, are most useful when stored in a digital memory that can be read by a digital processor. We use the term “computer-readable storage medium” (or alternatively, “machine-readable storage medium”) to include all of the foregoing types of memory, as well as new technologies that may arise in the future, as long as they are capable of storing digital information in the nature of a computer program or other data, at least temporarily, in such a manner that the stored information can be “read” by an appropriate digital processor. By the term “computer-readable” we do not intend to limit the phrase to the historical usage of “computer” to imply a complete mainframe, mini-computer, desktop or even laptop computer. Rather, we use the term to mean that the storage medium is readable by a digital processor or any digital computing system. Such media may be any available media that is locally and/or remotely accessible by a computer or processor, and it includes both volatile and non-volatile media, removable and non-removable media.

### Computer Program Product

Where a program has been stored in a computer-readable storage medium, we may refer to that storage medium as a computer program product. For example, a portable digital storage medium may be used as a convenient means to store and transport (deliver, buy, sell, license) a computer program. This was often done in the past for retail point-of-sale delivery of packaged (“shrink wrapped”) programs. Examples of such storage media include without limitation CD-ROM and the like. Such a CD-ROM, containing a stored computer program, is an example of a computer program product.

It will be obvious to those having skill in the art that many changes may be made to the details of the above-described embodiments without departing from the underlying principles of the invention. The scope of the present invention should, therefore, be determined only by the following claims.

1. A method, comprising:
receiving preference data for a user into a database, wherein the preference data is associated with media;
storing the preference data in a database;
associating the preference data with a specific portable device;
detecting the physical presence of the portable device; and
displaying a media item of the media associated with the preference data of the detected user portable device on a collage display.

2. The method of claim 1, wherein the preference data comprises a media file, a link to a media file, a username, a media file name, an avatar, a text message, or combinations thereof, and wherein the user portable device has an associated username and an associated avatar.

3. The method of claim 2, further comprising:
displaying a welcome screen on the collage display upon the detecting; and
displaying the avatar and the username associated with each detected user portable device in a queue of detected user portable devices on the collage display.

4. The method of claim 3, further comprising:
receiving a text message from the detected portable device, wherein the detected portable device is a wireless device; and
displaying the received text message above the avatar associated with the user portable device from which the text message was received.

5. The method of claim 1, wherein the user portable device comprises a customer loyalty card or a wireless device, and wherein the detecting is accomplished with a magnetic card reader, a barcode scanner, a wi-fi router, or a Bluetooth scanner.

6. The method of claim 1, wherein the collage display incrementally displays associated media from multiple users, and wherein the displayed media is initially displayed as a large image located in the center of the collage display and then gradually recedes into the background of the collage display to a predetermined position.

7. The method of claim 1, further comprising:
receiving user feedback about the displayed media item;
displaying the user feedback on the collage display; and
displaying the user feedback on an internet website, along with a thumbnail image of the displayed media item.

8. The method of claim 7, wherein the user feedback comprises user comments, “thumbs up” votes, “thumbs down” votes, or combinations thereof.

9. The method of claim 7, wherein the user feedback is used to determine a frequency of display of the media item that the user feedback was provided for.

10. The method of claim 1, further comprising:
determining an order of media item display for a plurality of detected user portable devices with an algorithm whose factors include a date and time of presence detection, a positivity score, a number of “thumbs up” votes, a number of “thumbs down” votes, a last display score, a presence score, an activity score, an age score, or combinations thereof, wherein media items are displayed in the determined order.

11. A system, comprising:
a server configured to receive user preference data, wherein the user preference data is associated with media;
a database on the server configured to store the user preference data;
a user portable device configured to be carried by the user, wherein the user portable device is associated with the user preference data through the database;
a device detector configured to detect the presence of the user portable device; and
a collage display configured to display received user preference data upon detection of the associated user portable device.

12. The system of claim 11, wherein the preference data comprises a media file, a link to a media file, a username, a media file name, an avatar, a text message, or combinations thereof, and wherein the user portable device has an associated username and an associated avatar.

13. The system of claim 12, further comprising:
a welcome screen on the collage display that is shown, along with the associated username and the associated avatar upon the initial detection of the user portable device; and
a queue of recently detected user portable devices on the collage display.

14. The system of claim 11, wherein the user portable device comprises a customer loyalty card or a wireless device, and wherein the device detector comprises a magnetic card reader, a barcode scanner, a wi-fi router, or a Bluetooth scanner.

15. The system of claim 11, further comprising an internet website on the website configured to accept user profile data, user media feedback data, and to display the user profile data, user media, and user media feedback data.

16. The system of claim 15, wherein the user media feedback data determines a frequency of display of a media item pertaining to the user media feedback data.

17. A system, comprising:
means for receiving preference data for a user into a database, wherein the preference data is associated with media;
means for storing the preference data in a database;
means for linking the preference data to a user portable device;
means for detecting the physical presence of the user portable device; and
means for displaying a media item of the media associated with the preference data of the detected user portable device on a collage display.

18. The system of claim 17, further comprising:
means for displaying a welcome screen on the collage display upon the detecting;
means for displaying the avatar and the username associated with each detected user portable device in a queue of detected user portable devices on the collage display;
means for receiving a text message from the detected portable device, wherein the detected portable device is a wireless device; and
means for displaying the received text message above the avatar associated with the user portable device from which the text message was received.

19. A computer-readable medium having instructions stored thereon, wherein when the instructions are executed by at least one device, the device is operable to:
receive preference data for a user into a database, wherein the preference data is associated with media;
store the preference data in a database;
link the preference data to a user portable device;
detect the physical presence of the user portable device; and
display a media item of the media associated with the preference data of the detected user portable device on a collage display.

20. The computer-readable medium of claim 19, wherein the device is further operable to:
receive user feedback about the displayed media item;
display the user feedback on the collage display;
display the user feedback on an internet website, along with a thumbnail image of the displayed media item; and
determine an order of media item display for a plurality of detected user portable devices with an algorithm whose factors include a date and time of presence detection, a positivity score, a number of “thumbs up” votes, a number of “thumbs down” votes, a last display score, a presence score, an activity score, an age score, or combinations thereof, wherein media items are displayed in the determined order.
